(19) United States
(12) Patent Application Publication
(10) Pub. No.: US 2025/0084829 A1
(43) Pub. Date: Mar. 13, 2025

(54) METHOD AND MOUNTING DEVICE FOR ASSEMBLING A ROTOR BEARING

(71) Applicant: Miba Gleitlager Austria GmbH, Laakirchen (AT)

(72) Inventors: Johannes HOELZL, Berg im Attergau (AT); Albert WALDL, Laakirchen (AT); Patrick LAUBICHLER, Gmunden (AT)

(73) Assignee: Miba Gleitlager Austria GmbH, Laakirchen (AT)

(21) Appl. No.: 18/580,760

(22) PCT Filed: Jul. 19, 2022
(86) PCT No.: PCT/AT2022/060257

§ 371 Date: Jan. 19, 2024

(30) Foreign Application Priority Data
Jul. 20, 2021 (AT) A50600/2021

(51) Int. Cl. F03D 13/10; F03D 80/70; F16C 17/02; F16C 43/02

(52) U.S. Cl. CPC F03D 13/104; F03D 80/70; F16C 17/02; F16C 43/02; F05B 2230/608; F05B 2230/6102; F16C 2360/31

(57) ABSTRACT

A method for assembling a rotor bearing of a wind turbine, includes the method steps: providing a rotor shaft; providing an outer ring element; providing individual sliding bearing pads; positioning the rotor shaft and the outer ring element relative to one another, such that the rotor shaft is arranged in its desired axial position within the outer ring element; subsequent individual insertion of the sliding bearing pads in an intermediate space between the rotor shaft and the outer ring element.

The invention relates to a method and a mounting device for assembling a rotor bearing.

A bearing element for bearing the rotor hub of a wind turbine is known from WO 2011/127510 A1.

Such bearings, as are known from WO 2011/127510 A1, are difficult to install due to their size.

The object of the present invention was to overcome the shortcomings of the prior art and to provide a method and a device by means of which a simplified installation of the rotor bearing is possible.

This object is achieved by means of a device and a method according to the claims.

This object is achieved by means of a device and a method according to the claims.

According to the invention, a method for assembling a rotor bearing of a wind turbine is provided. The method comprises the method steps:
providing a rotor shaft;
providing an outer ring element;
providing individual sliding bearing pads;
positioning the rotor shaft and the outer ring element relative to one another, such that the rotor shaft is arranged in its desired axial position within the outer ring element;
subsequent individual insertion of the sliding bearing pads in an intermediate space between the rotor shaft and the outer ring element.

The method according to the invention entails the advantage that by the method steps described, the assembly of the rotor bearing is simplified. Thus, the rotor bearing structured according to the method can have an improved quality.

According to an advantageous advancement, it may be provided that the assembly of the rotor bearing is performed distant from a nacelle of a wind turbine and that, in a subsequent method step, the fully assembled rotor bearing is lifted onto the nacelle of the wind turbine by means of a crane and attached to the nacelle of the wind turbine. This entails the advantage that the rotor bearing can be assembled in a specially equipped environment, such as a machine hall or in a construction tent which is arranged in a wind farm. This means that the rotor bearing can be assembled under shielded environmental conditions. In addition, this measure can simplify the assembly of the rotor bearing, as the assembly does not have to take place inside the nacelle of the wind turbine.

Furthermore, it may be useful if the axial position of the rotor shaft and the outer ring element relative to one another is adjusted by means of axial positioning means, wherein the axial positioning means are supported on a rotor shaft flange of the rotor shaft and on the outer ring element or a bearing block in which the outer ring element is received, wherein the axial positioning means are adjustable in length, wherein at least three of the axial positioning means are distributed over the circumference of the rotor shaft. This entails the advantage that the position of the rotor shaft and the outer ring element is determined before the individual sliding bearing pads are inserted into the intermediate space between the rotor shaft and the outer ring element, so that damage to the individual components of the rotor bearing is prevented as far as possible when the sliding bearing pads are inserted.

Furthermore, it may be provided that the radial position of the rotor shaft and the outer ring element relative to each other is adjusted by means of radial positioning means, wherein the radial positioning means are supported on an outer lateral surface of the rotor shaft and on an inner lateral surface of the outer ring element or a bearing block in which the outer ring element is received, wherein the radial positioning means are adjustable in length, wherein at least three of the radial positioning means are distributed over the circumference of the rotor shaft. This entails the advantage that the position of the rotor shaft and the outer ring element is determined before the individual sliding bearing pads are inserted into the intermediate space between the rotor shaft and the outer ring element, so that damage to the individual components of the rotor bearing is prevented as far as possible when the sliding bearing pads are inserted.

In addition, it may be provided that a circumferential guide rail is mounted on a first axial end face of the outer ring element or of the bearing block in which the outer ring element is received, wherein a guide carriage is arranged on the guide rail. This entails the advantage that the guide carriage can be used to receive various devices and can be used to precisely guide these devices relative to the rotor shaft or relative to the outer ring element and/or relative to the bearing block. In particular, the guide carriage can be used to guide the devices coaxially to the outer ring element or to the bearing block and thus also coaxially to the rotor shaft if the rotor shaft is positioned precisely.

Furthermore, it may be provided that the guide rail is arranged on the outer ring element or on the bearing block in such a way that it is positioned coaxially to the outer ring element or to the bearing block.

An embodiment, according to which it may be provided that a dial gauge is arranged on the guide carriage, wherein a measuring probe of the dial gauge is applied to the rotor shaft to determine the coaxiality of the rotor shaft to the outer ring element and the dial gauge is subsequently guided in a circle on the rotor shaft by means of the guide carriage, is also advantageous. The entails the advantage that by this measure the rotor shaft can be precisely aligned with the outer ring element and/or the bearing block.

According to an advancement, it is possible that before inserting the sliding bearing pads into an intermediate space between the rotor shaft and the outer ring element, a fastening receptacle is arranged on a first end face of one of the sliding bearing pads, wherein the fastening receptacle has a crane hook for lifting the sliding bearing pad into the intermediate space between the rotor shaft and the outer ring element, wherein the sliding bearing pad is inserted through a removal opening into the intermediate space between the rotor shaft and the outer ring element. This entails the advantage that the sliding bearing pad can be easily lifted into the intermediate space between the rotor shaft and the outer ring element by means of the fastening receptacle. In particular, a lifting device such as a crane can be used for this purpose.

Furthermore, it can be useful if, after inserting the sliding bearing pad into the intermediate space between the rotor shaft and the outer ring element through a removal opening, the fastening receptacle is fastened to the guide carriage and the sliding bearing pad is moved to its target position in the circumferential direction by means of the guide carriage. This entails the advantage that, by this measure, the individual sliding bearing pad can be moved to its target position in a targeted manner.

In particular, it can be provided in this regard that a retaining arm of the fastening receptacle can protrude in an annular gap between the rotor shaft and the outer ring element.

According to the invention, a rotor bearing mounting device for assembling a rotor bearing of a wind turbine is formed. The rotor bearing mounting device comprises a guide rail which is configured for mounting on an axial end face of a bearing block. Furthermore, the rotor bearing mounting device comprises a guide carriage which is slidably mounted on the guide rail.

The rotor bearing mounting device according to the invention entails the advantage that by means of it, a simplified installation of the individual sliding bearing pads in the rotor bearing may be achieved.

Furthermore, it can be provided that a fastening receptacle is formed, on which a sliding bearing pad receiving surface is formed, which is configured for coupling with sliding bearing pads, wherein the fastening receptacle can be coupled with the guide carriage. This entails the advantage that the individual sliding bearing pads can be received by means of the fastening receptacle and the individual sliding bearing pads can be manipulated together with the fastening receptacle. In particular, the fastening receptacle can be attached to the guide carriage and/or removed from the guide carriage together with the sliding bearing pads attached to it.

According to a particular embodiment, it is possible that the guide carriage has a first carriage part, which is configured for coupling with the guide rail, and that the guide carriage has a second carriage part, which is configured for coupling with the fastening receptacle, wherein the first carriage part is displaceable in a radial direction relative to the second carriage part. This entails the advantage that, by this measure, the sliding bearing pad received on the fastening receptacle can be displaced in the radial direction into its correct position so that it can be screwed to the rotor shaft and/or to a sliding bearing pad receiving ring received on the rotor shaft.

According to an advantageous advancement, it may be provided that the fastening receptacle has a tilting mechanism, such that the sliding bearing pad can be tilted relative to the guide carriage. This entails the advantage that, by this measure, the sliding bearing pad received on the fastening receptacle can be displaced in the radial direction into its correct position so that it can be screwed to the rotor shaft and/or to a sliding bearing pad receiving ring received on the rotor shaft.

In particular, it can be advantageous if the tilting mechanism comprises a fastening screw which is received in a first bore on a side facing the sliding bearing pad receiving surface and which is received in a second bore on a side facing away from the sliding bearing pad receiving surface, wherein the second bore has a larger diameter than the first bore and that the fastening screw is displaceable in the radial direction within the second bore. In particular, a tilting mechanism configured in this way has a simple structure and is therefore robust and reliable.

Furthermore, it may be provided that at least one spring element, which pretensions the fastening screw in the axial direction, is received in the second bore.

Furthermore, it may be provided that the fastening receptacle has a height adjustment mechanism by means of which the sliding bearing pads can be displaced in the axial direction. This entails the advantage that, thereby, the individual sliding bearing pads, once they have been moved to the correct position in the circumferential direction, can be brought into contact with the rotor shaft and/or the sliding bearing pad receiving ring so that the sliding bearing pads can be screwed to the rotor shaft and/or the sliding bearing pad receiving ring.

In addition, it may be provided that the fastening receptacle has a positioning pin, which is configured to interact with a through hole formed in the sliding bearing pad, in the region of the sliding bearing pad receiving surface. This entails the advantage that, by this measure, simple positioning of the sliding bearing pad on the fastening receptacle can be achieved.

For the purpose of better understanding of the invention, it will be elucidated in more detail by means of the figures below.

These show in a respectively very simplified schematic representation:

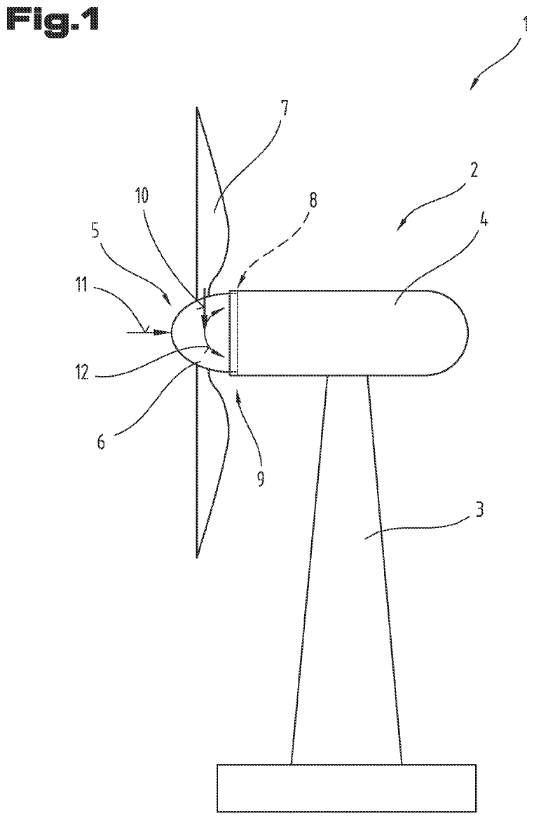

FIG. 1 a schematic representation of a wind turbine;

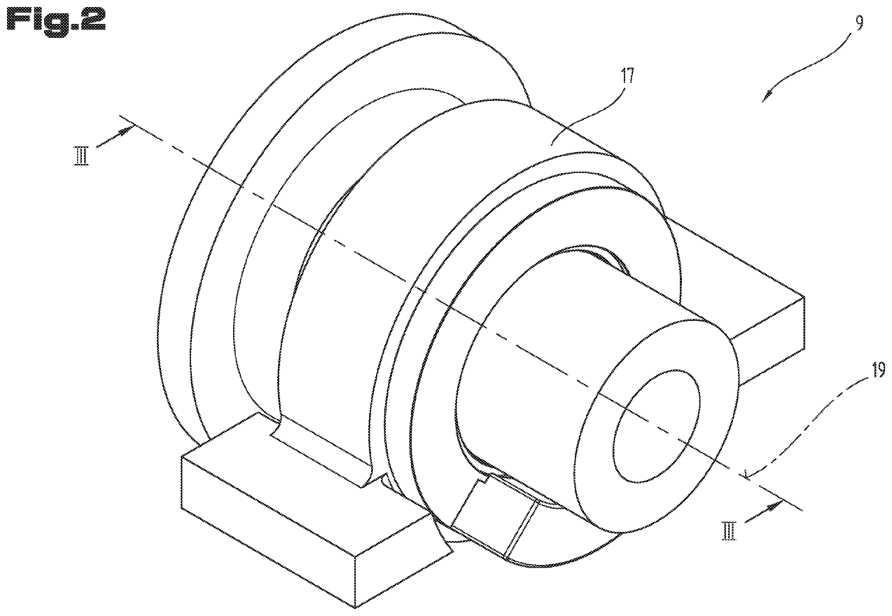

FIG. 2 a perspective representation of a first exemplary embodiment of a sliding bearing;

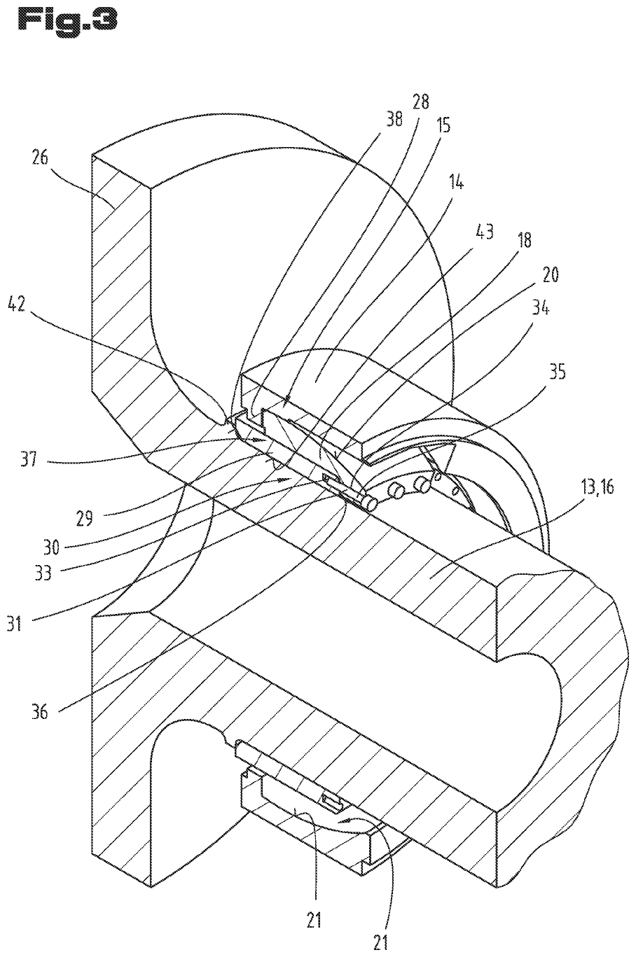

FIG. 3 a perspective sectional view of the first exemplary embodiment of the sliding bearing;

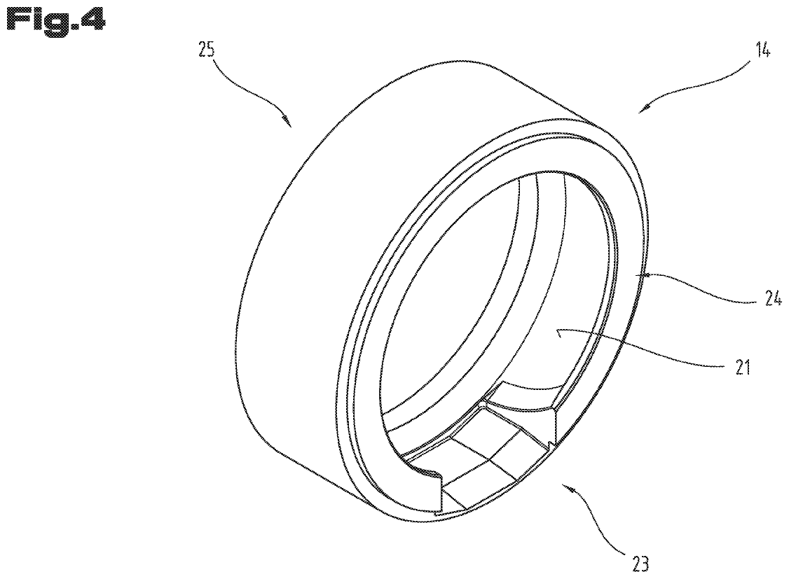

FIG. 4 a schematic representation of an exemplary embodiment of the outer ring;

FIG. 5 a schematic representation of an exemplary embodiment of the sliding bearing pads bearing in a first view;

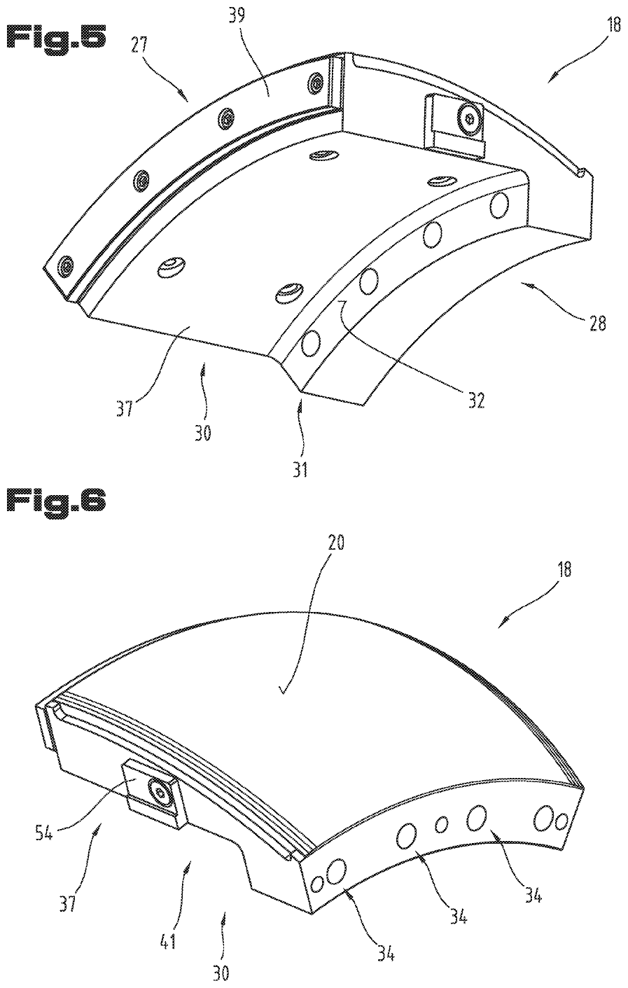

FIG. 6 a schematic representation of an exemplary embodiment of the sliding bearing pads bearing in a second view;

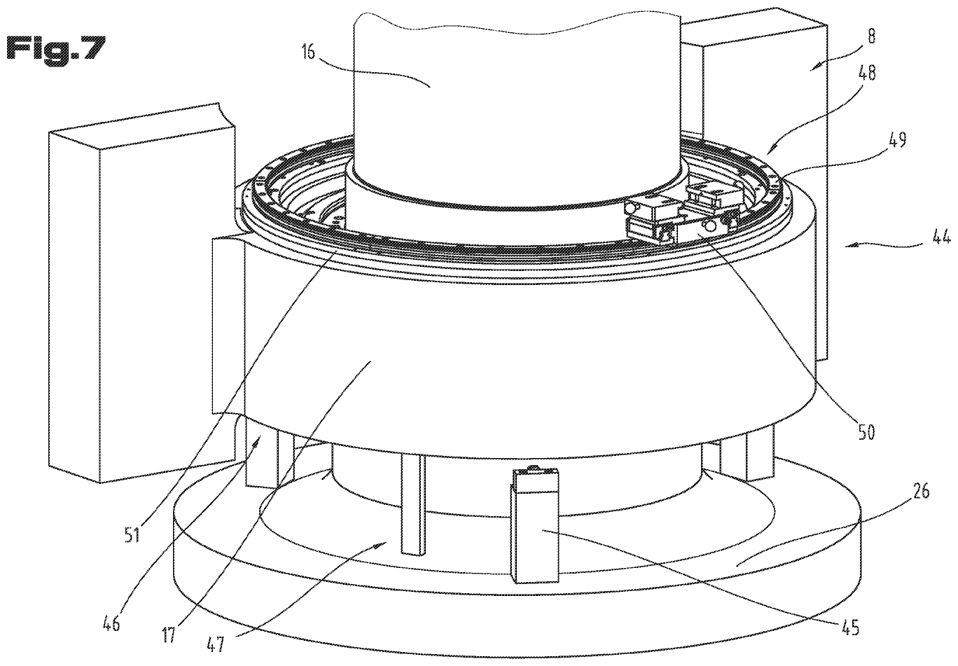

FIG. 7 a first joining step for joining a rotor shaft to a bearing block;

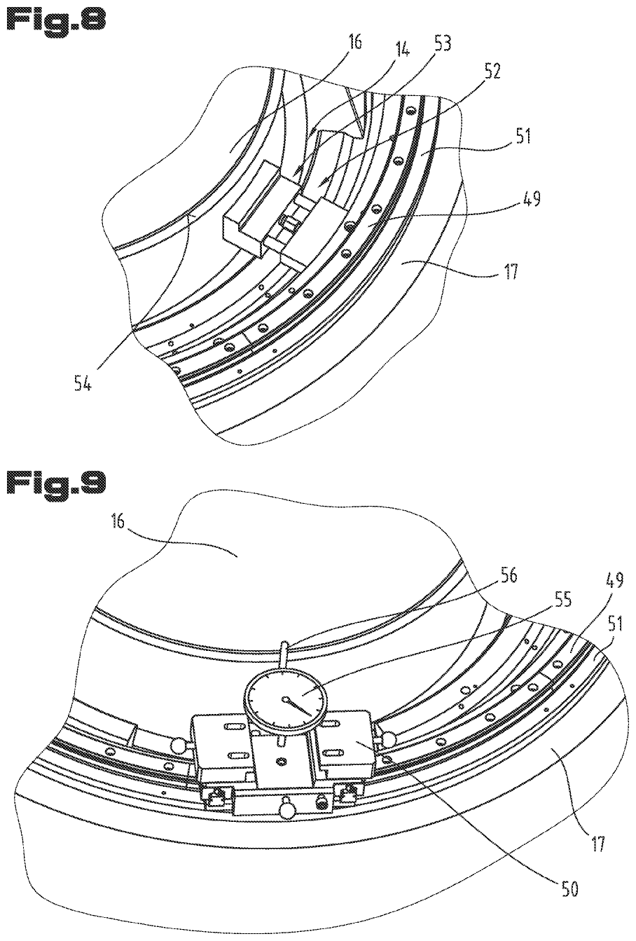

FIG. 8 a representation of a radial positioning means;

FIG. 9 a representation of a dial gauge mounted on a guide carriage;

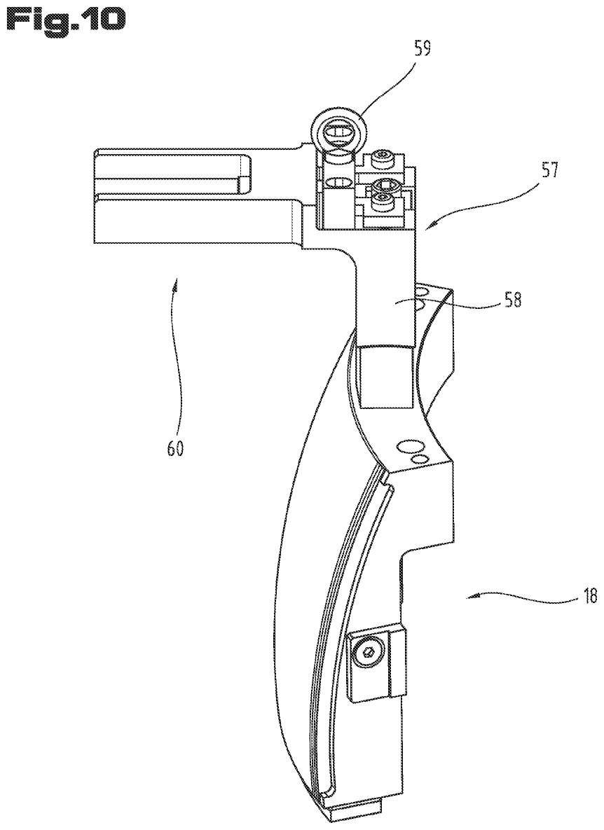

FIG. 10 a fastening receptacle with a sliding bearing pad received thereon;

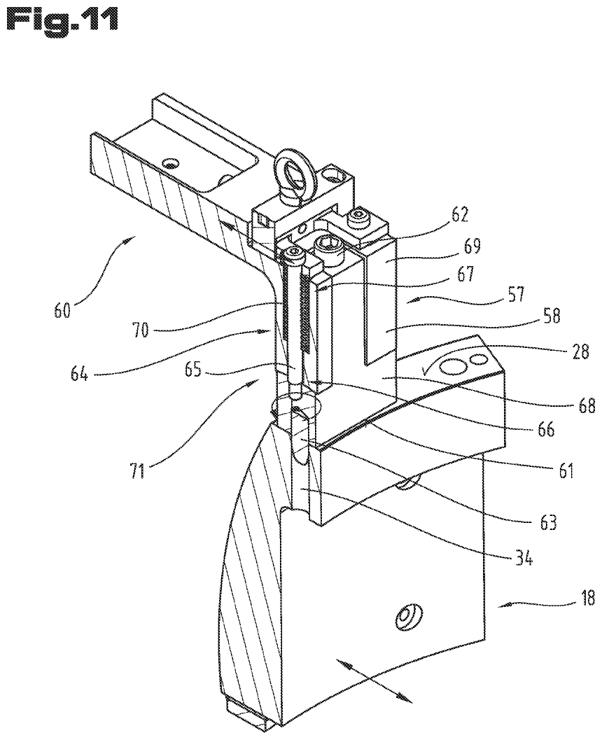

FIG. 11 a sectional view of the fastening receptacle with the sliding bearing pad received thereon;

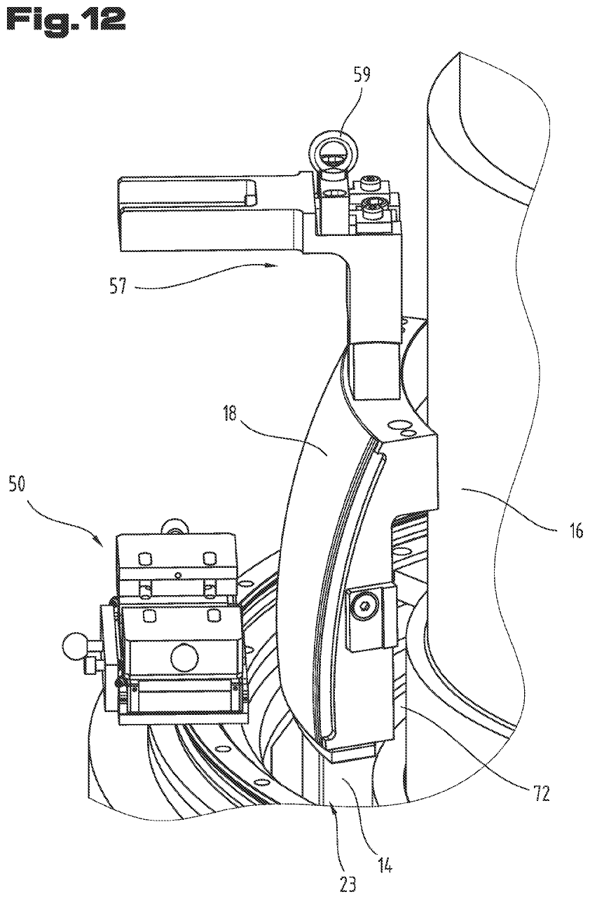

FIG. 12 a representation of a method step for inserting the sliding bearing pad between the rotor shaft and the outer ring element;

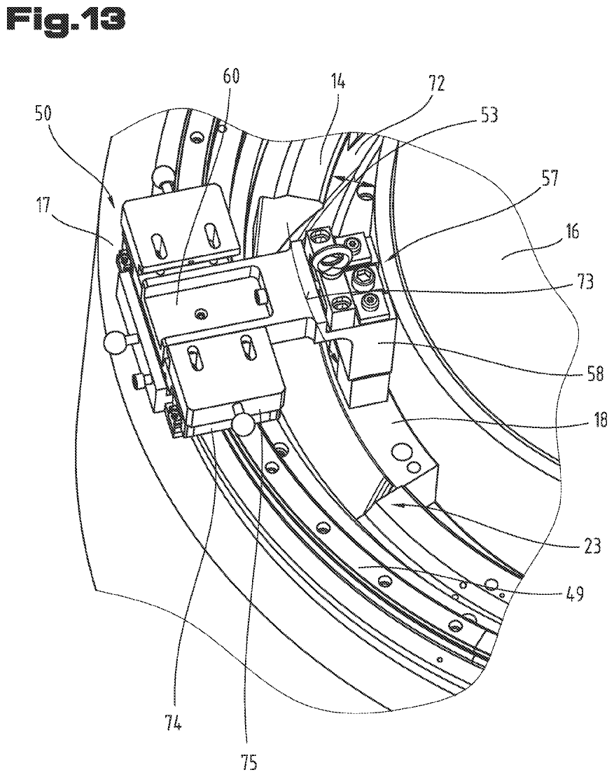

FIG. 13 a representation of a method step for displacing the sliding bearing pad between the rotor shaft and the outer ring element in the circumferential direction;

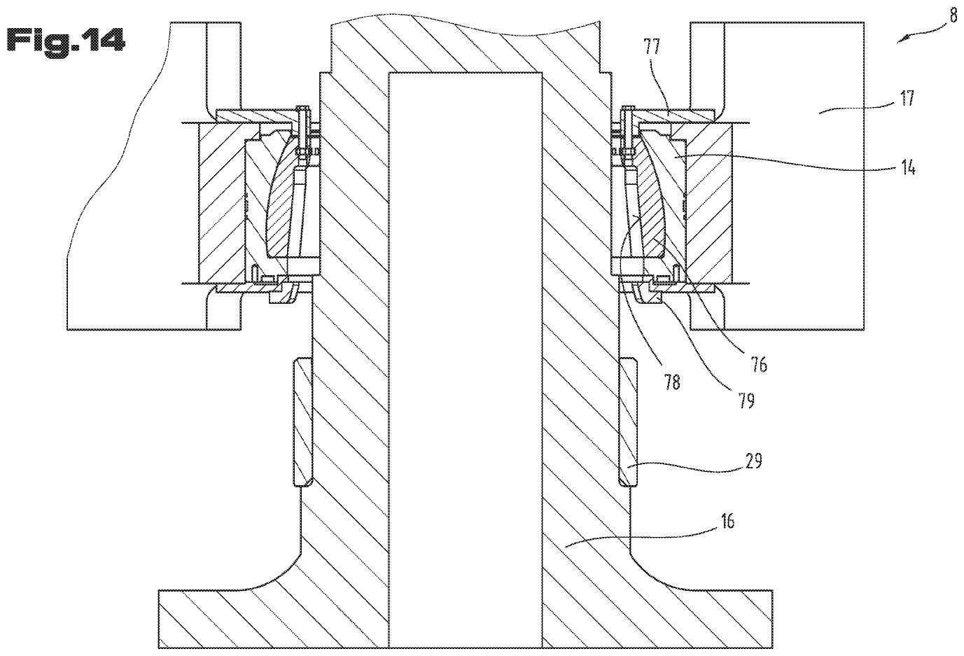

FIG. 14 a sectional view of an additional method step for assembling the sliding bearing.

First of all, it is to be noted that in the different embodiments described, equal parts are provided with equal reference numbers and/or equal component designations, where the disclosures contained in the entire description may be analogously transferred to equal parts with equal reference numbers and/or equal component designations. Moreover, the specifications of location, such as at the top, at the bottom, at the side, chosen in the description refer to the directly described and depicted figure and in case of a change of position, these specifications of location are to be analogously transferred to the new position.

FIG. 1 shows, in a schematic view, a first exemplary embodiment of a wind turbine 1 for generating electrical energy from wind energy. The wind turbine 1 comprises a nacelle 2, which is rotatably received on a tower 3. The nacelle 2 comprises a nacelle housing 4, which forms the main structure of the nacelle 2. In the nacelle housing 4 of the nacelle 2, the electrotechnical components such as a generator of the wind turbine 1 are arranged.

Moreover, a rotor 5 is formed, which has a rotor hub 6 with rotor blades 7 arranged thereon. The rotor hub 6 is considered part of the nacelle 2. The rotor hub 6 is received so as to be rotatable on the nacelle housing 4 by means of a rotor bearing 8. In particular, it is provided that a sliding bearing 9 according to the invention and described in more detail below is used as a rotor bearing 8. In particular, it may be provided that the rotor hub 6 is arranged on a rotor shaft 16, wherein the rotor shaft 16 is mounted in the rotor bearing 8.

The rotor bearing 8, which serves for bearing the rotor hub 6 on the nacelle housing 4 of the nacelle 2, is configured for absorbing a radial force 10 and an axial force 11. The axial force 11 is caused by the force of the wind. The radial force 10 is caused by the weight force of the rotor 5 and is effective at the center of gravity of the rotor 5. As the center of gravity of the rotor 5 is outside the rotor bearing 8, a tilting torque 12 is generated in the rotor bearing 8 by the radial force 10. The tilting torque 12 may also be caused by an uneven load of the rotor blades 7. This tilting torque 12 can be absorbed by means of a second bearing, which is arranged at a distance from the rotor bearing 8. The second bearing may, for example, be formed in the region of the generator.

FIG. 2 shows a first exemplary embodiment of the sliding bearing 9 built into the nacelle 2. Of course, the sliding bearing 9 shown in FIG. 2 may also be used in all other industrial applications outside of wind turbines. The sliding bearing 9 is shown in a perspective view in FIG. 2.

FIG. 2 shows the first exemplary embodiment of the sliding bearing 9 in a perspective longitudinal section.

Below, the sliding bearing 9 will be described by means of a combination of FIGS. 2 and 3.

As can be seen from FIGS. 2 and 3, it may be provided that the sliding bearing 9 comprises an inner ring element 13 and an outer ring element 14. Between the inner ring element 13 and the outer ring element 14, a sliding bearing element 15 is arranged, which serves for the rotatory sliding bearing of the inner ring element 13 relative to the outer ring element 14.

In the exemplary embodiment shown in FIGS. 2 and 3, the inner ring element 13 is configured as a rotor shaft 16. Of course, the inner ring element 13 may also be another shaft. Furthermore, it is also conceivable that the inner ring element 13 is formed as a separate component which is received on a shaft, in particular on a rotor shaft 16.

As can particularly well be seen from FIG. 2, it may be provided that the outer ring element 14 is received in a bearing block 17. For the sake of clarity, the bearing block 17 is not shown in FIG. 3.

In particular, it may be provided that the bearing block 17 is coupled to the nacelle housing 4 or, alternatively, is formed directly in the nacelle housing 4. In this exemplary embodiment, it may thus be provided that the outer ring element 14 is rigidly coupled to the nacelle housing 4 and that the inner ring element 13 is rotatable about a rotation axis 19 relative to the outer ring element 14 by means of the sliding bearing element 15.

Furthermore, it may be provided that the bearing block 17 serves directly as the outer ring element 14.

Thus, the rotor shaft 16 is received rotationally in the nacelle housing 4 by means of the sliding bearing 9.

As can further be seen in FIGS. 2 and 3, it may be provided that the sliding bearing element 15 comprises multiple individual sliding bearing pads 18, which are arranged distributed across the circumference, between the inner ring element 13 and the outer ring element 14.

In the operating state of the sliding bearing 9, the individual sliding bearing pads 18 are fixedly coupled to the inner ring element 13 due to the structure shown in FIG. 3 and thus rotate along with it relative to the outer ring element 14. In order to enable the rotational movement between the inner ring element 13 and the outer ring element 14, on each of the individual sliding bearing pads 18 one bearing surface 20 is formed which abuts a counterface 21 of the outer ring element 14 in the operational state of the sliding bearing 9. The counterface 21 is arranged on the inner side 22 of the outer ring element 14.

The bearing surface 20 of the sliding bearing pad 18 and the counterface 21 of the outer ring element 14 are designed as sliding surfaces, which slide on one another during operation of the sliding bearing 9. In particular, it may be provided that the counterface 21 of the outer ring element 14 is configured as a hard, wear-resistant surface, which may be formed, for example, by a hardened steel. The bearing surface 20 of the sliding bearing pad 18 may be formed of a sliding bearing material which is soft in comparison to the counterface 21. Of course, it is also conceivable that the bearing surface 20 has an anti-friction coating.

As can particularly well be seen from FIG. 3, it may be provided that the individual sliding bearing pads 18 each have a bearing surface 20 that is curved as seen in the axial direction. In particular, it may be provided that the bearing surface 20 is formed as a spherical cap.

As can further be seen from FIG. 3, it may be provided that a removal opening 23, which serves for the axial removal and/or for the axial insertion of individual ones of the sliding bearing pads 18, is formed in the outer ring element 14.

FIG. 4 shows a perspective view of the outer ring element 14, wherein, again, equal reference numbers and/or component designations are used for equal parts as before in FIGS. 1 to 3. In order to avoid unnecessary repetitions, it is pointed to/reference is made to the detailed description in FIGS. 1 through 3 preceding it.

The removal opening 23 may be seen particularly well in FIG. 4.

As can be seen from FIGS. 3 and 4, it may be provided that the removal opening 23 at least in some sections interrupts the counterface 21 formed in the outer ring element 14. In particular, it may be provided that the removal opening 23 extends starting out from a first end 24 of the outer ring element 14. In particular, it may be provided that the removal opening 23 does not extend up to a second end face 25 of the outer ring element 14.

As can further be seen from FIG. 3, it may be provided that the rotor shaft 16 has a rotor shaft flange 26 which may serve to flange the rotor hub 6.

In FIG. 3, only a single sliding bearing pad 18 is shown for the sake of simplicity, although multiple ones of the sliding bearing pads 18 can be arranged evenly distributed around the circumference.

As can be seen from FIG. 3, it may be provided that a sliding bearing pad receiving ring 29, which serves to receive the individual sliding bearing pads 18, is arranged on the inner ring element 13.

FIGS. 5 and 6 show a detailed view of an embodiment of the sliding bearing pad 18 in various perspective views, wherein again equal reference numbers and/or component designations are used for equal parts as before in FIGS. 1 to 4. In order to avoid unnecessary repetitions, it is pointed to/reference is made to the detailed description in FIGS. 1 through 4 preceding it.

The further structure of the sliding bearing pads 18 and/or the sliding bearing 9 is described by means of the combination of FIGS. 3 to 6.

In particular, it may be provided that the individual sliding bearing pads 18 have a shoulder 31 on an inner side 30. The shoulder 31 can form a contact surface 32 such that the sliding bearing pad 18 can abut against a first end face 36 of the sliding bearing pad receiving ring 29 in the region of the shoulder 31. This allows the sliding bearing pad 18 to be positioned in the axial direction relative to the sliding bearing pad receiving ring 29.

Further, it may be provided that the shoulder 31 defines a recess 37 formed on the inner surface 30 of the sliding bearing pad 18. The recess 37 can extend from the second end face 28 of the sliding bearing pad 18 to the shoulder 31. The recess 37 and/or the shoulder 31 can be rotationally symmetrical, in particular as a rotational segment.

In particular, it may be provided that, in the installed state of the sliding bearing pad 18, the sliding bearing pad receiving ring 29 is at least partially received in the recess 37 of the sliding bearing pad 18.

Furthermore, it can be provided that multiple thread holes 33 are formed on the first end face 36 of the sliding bearing pad receiving ring 29. Corresponding to the thread holes 33, one, in particular multiple, axially extending through holes 34 can be formed on a second end face 28 of the sliding bearing pads 18.

Furthermore, fastening screws 35 can be guided through the through holes 34, which fastening screws 35 can be screwed into the thread holes 33 and thus serve to fasten the sliding bearing pads 18 to the sliding bearing pad receiving ring 29. By means of the fastening screws 35, the sliding bearing pads 18 can be pressed against the sliding bearing pad receiving ring 29 in the axial direction.

As can be seen from FIG. 3, it may be provided that a second end face 38 of the sliding bearing pad receiving ring 29 abuts a shaft bead 42. This allows the sliding bearing pad receiving ring 29 to be positioned axially on the inner ring element 13.

As can be seen particularly well from FIG. 5, it may be provided that a thrust ring segment 39 is arranged on a first end face 27 on the sliding bearing pad 18. The thrust ring segment 39 may serve to absorb axial forces between the sliding bearing pad 18 and the outer ring element 14. In particular, it may be provided that the thrust ring segment 39 has a sliding surface and that the outer ring element 14 has a counter sliding surface, wherein the sliding surface and the counter sliding surface abut one another and slide on one another in operation.

Furthermore, it may be provided that the thrust ring segment 39 is coupled to the second end face 28 of the sliding bearing pad 18 by means of fastening means.

As can further be seen from FIG. 3, it may be provided that the sliding bearing pad receiving ring 29 on its inner jacket surface 43 rests on the inner ring element 13. In particular, it may be provided that the sliding bearing pad receiving ring 29 is coupled to the inner ring element 13 by means of a press fit connection and/or by thermal shrink-fitting.

FIG. 7 shows a first exemplary embodiment of a rotor bearing mounting device 44.

The rotor bearing mounting device 44 serves for assembling the rotor bearing 8. In particular, the individual sliding bearing pads 18 can be inserted into the rotor bearing 8 by means of the rotor bearing mounting device 44.

As can be seen from FIG. 7, it can be provided that the rotor bearing mounting device 44 comprises an axial positioning means 45 by means of which the bearing block 17 and/or an outer ring element 14 received in the bearing block 17 can be positioned in the axial direction relative to the rotor shaft 16. As can be seen from FIG. 7, it can be provided that the axial positioning means 45 is supported on a first side on the rotor shaft flange 26 and that the axial positioning means 45 is supported on its second side on a second axial end face 46 of the bearing block 17.

Furthermore, an axial position detection means 47 can be formed, by means of which the axial distance between the rotor shaft flange 26 and the bearing block 17 can be detected. As can also be seen from FIG. 7, it can be provided that an axial position detection means 47 is arranged on the bearing block 17. The axial position detection means 47 can, for example, comprise an electronic distance sensor, which is used to detect the distance. Furthermore, a display unit can be formed by means of which the axial distance and/or the axial position of the rotor shaft flange 26 and/or the rotor shaft 16 relative to the outer ring element 14 and/or relative to the bearing block 17 can be displayed. The axial positioning means 45 can be used to set a desired distance. In particular, it may be provided that the axial positioning means 45 comprise a thread with an adjusting nut, wherein the longitudinal extent of the axial positioning means 45 can be increased or reduced by turning the adjusting nut.

As can also be seen from FIG. 7, it may be provided that a guide rail 49, which serves to receive a guide carriage 50, is attached to a first axial end face 48 of the bearing block 17. In particular, it may be provided that the guide rail 49 is arranged circularly around the rotor shaft 16. Preferably, the rotor shaft 16 is positioned relative to the outer ring element 14 and/or the bearing block 17 in such a way that the guide rail 49 and the rotor shaft 16 are arranged concentrically to each other.

As can also be seen from FIG. 7, it may be provided that one or more spacer rings 51 are arranged between the guide rail 49 and the bearing block 17. In particular, it may be provided that the spacer rings 51 and/or the guide rail 49 are screwed directly to the bearing block 17. The threaded holes arranged in the bearing block 17 that are used to screw a cover to the bearing block 17 can be used for this purpose. As shown in FIG. 8, a radial positioning means 52 can be provided, which is used for radial positioning of the rotor shaft 16 relative to the bearing block 17. In particular, the radial positioning means 52 can be used to evenly adjust an annular gap 53 between the rotor shaft 16 and the outer ring element 14. In particular, it may be provided that the radial positioning means 52 is supported on an outer lateral surface 54 of the rotor shaft 16.

Furthermore, the radial positioning means 52 can be supported on the bearing block 17 or on the outer ring element 14 or on the spacer ring 51 or on the guide rail 49.

In particular, it may be provided that the radial positioning means 52 is configured in multiple parts, wherein an inner support part, which is supported on the rotor shaft 16, and an outer support part, which is supported on the outer ring element 14 or on the bearing block 17 or on the spacer ring 51 or on the guide rail 49, are displaceable relative to each other. In particular, an adjusting screw can be configured to adjust the distance between the inner support part and the outer support part.

In particular, it may be provided that three of the radial positioning means 52 are arranged evenly distributed over the circumference of the rotor shaft 16 at an angular spacing of 120° to adjust the coaxiality.

As shown in FIG. 9, it can be provided that the guide carriage 50 is configured to receive a dial gauge 55 that has a measuring probe 56. The measuring probe 56 can be used for contact with the rotor shaft 16. To determine the coaxiality of the rotor shaft 16 and the bearing block 17 relative to each other, the dial gauge 55 can be guided in a circle by means of the guide carriage 50, wherein the surface of the rotor shaft 16 can be scanned by means of the measuring probe 56. If the rotor shaft 16 is arranged off-center relative to the bearing block 17, the radial positioning means 52 can be used to adjust the coaxiality. In particular, it can be provided that the dial gauge 55 and/or the guide carriage 50 are coupled to a digital computer, which is used to evaluate the measurement result and which can indicate a necessary adjustment of the radial positioning means 52.

As can be seen from FIG. 10, it can be provided that a fastening receptacle 57, by means of which the sliding bearing pad 18 can be manipulated, is arranged on the sliding bearing pad 18. In particular, it may be provided that the fastening receptacle 57 has a retaining arm 58 to which the sliding bearing pad 18 is attached. Furthermore, the fastening receptacle 57 can have a crane hook 59, which is used to lift the fastening receptacle 57 together with the sliding bearing pad 18. In particular, it may be provided that the crane hook 59 is positioned in such a way that when the sliding bearing pad 18 is aligned vertically, as shown in FIG. 10, the crane hook 59 lies in the center of gravity of the fastening receptacle 57 and the sliding bearing pad 18 arranged thereon.

As can also be seen in FIG. 10, it may be provided that the fastening receptacle 57 has a carriage receiving section 60 which is configured for coupling with the guide carriage 50.

As shown in FIG. 11, it can be provided that a sliding bearing pad receiving surface 61, against which the second end face 28 of the sliding bearing pad 18 can rest, is formed on the retaining arm 58 of the fastening receptacle 57. Furthermore, a sliding bearing pad fastening screw 62 can be provided, by means of which the second end face 28 of the sliding bearing pad 18 can be clamped against the sliding bearing pad receiving surface 61.

Furthermore, one or more positioning pins 63 can be formed, which serve to position the sliding bearing pad 18 relative to the fastening receptacle 57.

As can further be seen from FIG. 11, it can be provided that a tilting mechanism 64 is formed which serves to tilt the sliding bearing pad receiving surface 61 relative to the carriage receiving section 60. The tilting mechanism 64 can be formed by the fastening receptacle 57 having a first fastening receptacle part 68, on which the sliding bearing pad receiving surface 61 is formed, and a second fastening receptacle part 69, which is rigidly coupled to the carriage receiving section 60. The first fastening receptacle part 68 and the second fastening receptacle part 69 can be coupled to each other by means of a fastening screw 65. In particular, it may be provided that a first bore 66 and a second bore 67, through which the fastening screw 65 is inserted, are formed in the second fastening receptacle part 69. Furthermore, it may be provided that a thread hole, into which the fastening screw 65 is screwed, is formed in the first fastening receptacle part 68.

In particular, it may be provided that the first bore 66 and the second bore 67 are formed coaxially to each other. Furthermore, it may be provided that the fastening screw 65 is received in the first bore 66 with a small amount of play so that the fastening screw 65 can be tilted in the first bore 66. Furthermore, it may be provided that the fastening screw 65 is received in the second bore 67 with a larger amount of play so that the fastening screw 65 can be displaced in the radial direction of the fastening screw 65 in the region of the second bore 67. By forming the first bore 66 and the second bore 67 and/or by receiving the fastening screw 65 in the first bore 66 and the slidability of the fastening screw 65 in the second bore 67, tilting of the first fastening receptacle part 68 relative to the second fastening receptacle part 69 can be achieved.

As can also be seen from FIG. 11, it can be provided that, in the second bore 67, a spring element 70 is formed, which serves to pretension the fastening screw 65 in the axial direction of the fastening screw 65. A height adjustment mechanism 71 can be formed by the spring element 70, wherein the first fastening receptacle part 68 and the second fastening receptacle part 69 can be displaceable relative to one another in the axial direction of the sliding bearing pad 18. Such displaceability may be necessary when screwing the sliding bearing pad 18 to the sliding bearing pad receiving ring 29.

As can be seen from FIG. 12, it can be provided that the fastening receptacle 57 together with the sliding bearing pad 18 arranged thereon can be lifted by means of the crane hook 59 and inserted into an intermediate space 72 between the outer ring element 14 and the rotor shaft 16. In particular, it can be provided in this regard that the sliding bearing pad 18 is inserted axially into the outer ring element 14 in the region of the removal opening 23.

As can be seen in FIG. 13, the carriage receiving section 60 of the fastening receptacle 57 can be coupled to the guide carriage 50 in a subsequent method step. This allows the load of the sliding bearing pad 18 to be absorbed by the guide carriage 50. The sliding bearing pad 18 can subsequently be moved in a circumferential direction 73 into its desired position in the intermediate space 72 by means of the guide carriage 50. In particular, it may be provided that the retaining arm 58 protrudes through the annular gap 53 so that the sliding bearing pad 18 guided in the intermediate space 72 can be held by the guide carriage 50 arranged outside the intermediate space 72.

As can also be seen from FIG. 13, it can be provided that the guide carriage 50 has a first carriage part 74 which is coupled to the guide rail 49 and a second carriage part 75 to which the carriage receiving section 60 of the fastening receptacle 57 is coupled. The first carriage part 74 and the second carriage part 75 can be displaced relative to each other in the radial direction of the sliding bearing pad 18, whereby the radial position of the sliding bearing pad 18 relative to the rotor shaft 16 can be adjusted.

When the sliding bearing pad 18 is fixed in its target position, it can be screwed to the sliding bearing pad receiving ring 29 using the fastening screws 35. The sliding bearing pad fastening screw 62 can then be loosened so that the fastening receptacle 57 can be removed from the sliding bearing pad 18 and a new sliding bearing pad 18 can be attached to the fastening receptacle 57.

FIG. 14 shows a sectional view of an additional method step for assembling the rotor bearing 8, wherein, again, equal reference numbers and/or component designations are used for equal parts as before in FIGS. 1 to 13. In order to avoid unnecessary repetitions, it is pointed to/reference is made to the detailed description in FIGS. 1 through 13 preceding it.

As shown in FIG. 14, it can be provided that at least two, preferably three, alignment pads 76 are inserted into the outer ring element 14 for axial joining of the rotor shaft 16 and the outer ring element 14 before the joining process is started. In this regard, the alignment pads 76 can be screwed to the nacelle housing 4. In particular, it can be provided that the alignment pads 76 are held directly on the nacelle housing 4 by means of alignment pad holders 77. The alignment pads 76 can be positioned at a position provided for sliding bearing pads 18 in the outer ring element 14.

As can also be seen from FIG. 14, it can be provided that the alignment pads 76 are conical on the inner side 78 in order to facilitate axial joining and radial pre-centring of the rotor shaft 16 and the outer ring element 14.

Furthermore, it can be provided that an alignment piece 79 is positioned in the region of the second end face 25 of the outer ring element 14. The alignment piece 79 can additionally facilitate the joining of the rotor shaft 16 and the outer ring element 14. Furthermore, it may be provided that the alignment piece 79 also has a conical shape. In other words, the alignment piece 79 may have a cross-section that widens in the axial direction.

When the outer ring element 14 is positioned on the rotor shaft 16 in the axial direction and is also positioned in the radial direction at the same time by means of the alignment pads 76, the alignment pads 76 can be removed from the outer ring element 14 through the removal opening 23 and replaced by sliding bearing pads 18.

For more precise radial positioning of the outer ring element 14 and the rotor shaft 16 relative to each other, the radial positioning means 52 can be used as described in respect of FIG. 8, and/or further assembly can be carried out as described above in respect of FIG. 8 and the following figures.

The exemplary embodiments show possible embodiment variants, and it should be noted in this respect that the invention is not restricted to these particular illustrated embodiment variants of it, but that rather also various combinations of the individual embodiment variants are possible and that this possibility of variation owing to the technical teaching provided by the present invention lies within the ability of the person skilled in the art in this technical field.

The scope of protection is determined by the claims. Nevertheless, the description and drawings are to be used for construing the claims. Individual features or feature combinations from the different exemplary embodiments shown and described may represent independent inventive solutions. The object underlying the independent inventive solutions may be gathered from the description.

All indications regarding ranges of values in the present description are to be understood such that these also comprise random and all partial ranges from it, for example, the indication 1 to 10 is to be understood such that it comprises all partial ranges based on the lower limit 1 and the upper limit 10, i.e. all partial ranges start with a lower limit of 1 or larger and end with an upper limit of 10 or less, for example 1 through 1.7, or 3.2 through 8.1, or 5.5 through 10.

Finally, as a matter of form, it should be noted that for ease of understanding of the structure, elements are partially not depicted to scale and/or are enlarged and/or are reduced in size.

List of reference numbers

| | |
|---|---|
| 1 | Wind turbine |
| 2 | Nacelle |
| 3 | Tower |
| 4 | Nacelle housing |
| 5 | Rotor |
| 6 | Rotor hub |
| 7 | Rotor blade |
| 8 | Rotor bearing |
| 9 | Sliding bearing |
| 10 | Radial force |
| 11 | Axial force |
| 12 | Tilting torque |
| 13 | Inner ring element |
| 14 | Outer ring element |
| 15 | Sliding bearing element |
| 16 | Rotor shaft |
| 17 | Bearing block |
| 18 | Sliding bearing pad |
| 19 | Axis of rotation |
| 20 | Bearing surface |
| 21 | Counterface |
| 22 | Inner side |
| 23 | Removal opening |
| 24 | First end face of outer ring element |
| 25 | Second end face of outer ring element |
| 26 | Rotor shaft flange |
| 27 | First end face |
| 28 | Second end face |
| 29 | Sliding bearing pad receiving ring |
| 30 | Inner side |
| 31 | Shoulder |
| 32 | Contact surface |
| 33 | Thread hole |
| 34 | Through hole |
| 35 | Fastening screw |
| 36 | First end face of sliding bearing pad receiving ring |
| 37 | Recess |
| 38 | Second end face of sliding bearing pad receiving ring |
| 39 | Thrust ring segment |
| 40 | Spacer |
| 41 | Circumferential sides |
| 42 | Shaft bead |
| 43 | Inner jacket surface of sliding bearing pad receiving ring |
| 44 | Rotor bearing mounting device |
| 45 | Axial positioning means |
| 46 | Second axial end face of bearing block |
| 47 | Axial position detection means |
| 48 | First axial end face of bearing block |
| 49 | Guide rail |
| 50 | Guide carriage |
| 51 | Spacer ring |
| 52 | Radial positioning means |
| 53 | Annular gap |
| 54 | Outer lateral surface of rotor shaft |
| 55 | Dial gauge |
| 56 | Measuring probe |
| 57 | Fastening receptacle |
| 58 | Retaining arm |
| 59 | Crane hook |
| 60 | Carriage receiving section |
| 61 | Sliding bearing pad receiving surface |
| 62 | Sliding bearing pad fastening screw |
| 63 | Positioning pin |
| 64 | Tilting mechanism |
| 65 | Fastening screw |
| 66 | First bore |
| 67 | Second bore |
| 68 | First fastening receptacle part |
| 69 | Second fastening receptacle part |
| 70 | Spring element |
| 71 | Height adjustment mechanism |
| 72 | intermediate space |
| 73 | Circumferential direction |
| 74 | First carriage part |
| 75 | Second carriage part |
| 76 | Alignment pad |
| 77 | Alignment pad holder |
| 78 | Inner side of alignment pad |
| 79 | Alignment piece |

1. A method of assembling a rotor bearing (8) of a wind turbine (1), comprising the method steps:
providing a rotor shaft (16);
providing an outer ring element (14);
providing individual sliding bearing pads (18);
positioning the rotor shaft (16) and the outer ring element (14) relative to one another, such that the rotor shaft (16) is arranged in its desired axial position within the outer ring element (14); and
subsequent individual insertion of the sliding bearing pads (18) in an intermediate space (72) between the rotor shaft (16) and the outer ring element (14).

2. The method according to claim 1, wherein the axial position of the rotor shaft (16) and the outer ring element (14) relative to one another is adjusted by means of axial positioning means (45), wherein the axial positioning means (45) are supported on a rotor shaft flange (26) of the rotor shaft (16) and on the outer ring element (14) or a bearing block (17) in which the outer ring element (14) is received, wherein the axial positioning means (45) are adjustable in length, wherein at least three of the axial positioning means (45) are distributed over the circumference of the rotor shaft (16).

3. The method according to claim 1, wherein the radial position of the rotor shaft (16) and the outer ring element (14) relative to each other is adjusted by means of radial positioning means (52), wherein the radial positioning means (52) are supported on an outer lateral surface (54) of the rotor shaft (16) and on an inner lateral surface of the outer ring element (14) or a bearing block (17) in which the outer ring element (14) is received, wherein the radial positioning means (52) are adjustable in length, wherein at least three of the radial positioning means (52) are distributed over the circumference of the rotor shaft (16).

4. The method according to claim 1, wherein a circumferential guide rail (49) is mounted on a first axial end face (48) of the outer ring element (14) or of the bearing block (17) in which the outer ring element (14) is received, wherein a guide carriage (50) is arranged on the guide rail (49).

5. The method according to claim 4, wherein a dial gauge (55) is arranged on the guide carriage (50), wherein a measuring probe (56) of the dial gauge (55) is applied to the rotor shaft (16) to determine the coaxiality of the rotor shaft (16) to the outer ring element (14) and the dial gauge (55) is subsequently guided in a circle on the rotor shaft (16) by means of the guide carriage (50).

6. The method according to claim 1, wherein, before inserting the sliding bearing pads (18) into an intermediate space (72) between the rotor shaft (16) and the outer ring element (14), a fastening receptacle (57) is arranged on a first end face (27) of one of the sliding bearing pads (18), wherein the fastening receptacle (57) has a crane hook (59) for lifting the sliding bearing pad (18) into the intermediate space (72) between the rotor shaft (16) and the outer ring element (14), wherein the sliding bearing pad (18) is inserted through a removal opening (23) into the intermediate space (72) between the rotor shaft (16) and the outer ring element (14).

7. The method according to claim 6, wherein, after inserting the sliding bearing pad (18) into the intermediate space (72) between the rotor shaft (16) and the outer ring element (14) through a removal opening (23), the fastening receptacle (57) is fastened to the guide carriage (50) and the sliding bearing pad (18) is moved to its target position in the circumferential direction (73) by means of the guide carriage (50).

8. A rotor bearing mounting device (44) for assembling a rotor bearing (8) of a wind turbine (1), for performing the method according to claim 1, wherein a guide rail (49) is formed, which is configured for mounting on a first axial end face (48) of a bearing block (17), and wherein a guide carriage (50) is formed, which is displaceably received on the guide rail (49).

9. The rotor bearing mounting device (44) according to claim 8, wherein a fastening receptacle (57) is formed, on which a sliding bearing pad receiving surface (61) is formed, which is configured for coupling with sliding bearing pads (18), wherein the fastening receptacle (57) is couplable with the guide carriage (50).

10. The rotor bearing mounting device (44) according to claim 9, wherein the guide carriage (50) has a first carriage part (74), which is configured for coupling with the guide rail (49), and that wherein the guide carriage (50) has a second carriage part (75), which is configured for coupling with the fastening receptacle (57), wherein the first carriage part (74) is displaceable in a radial direction relative to the second carriage part (75).

11. The rotor bearing mounting device (44) according to claim 9, wherein the fastening receptacle (57) has a tilting mechanism (64) so that the sliding bearing pad (18) is tiltable relative to the guide carriage (50).

12. The rotor bearing mounting device (44) according to claim 11, wherein the tilting mechanism (64) comprises a fastening screw (65) which is received in a first bore (66) on a side facing the sliding bearing pad receiving surface (61) and which is received in a second bore (67) on a side facing away from the sliding bearing pad receiving surface (61), wherein the second bore (67) has a larger diameter than the first bore (66) and wherein the fastening screw (65) is displaceable in the radial direction within the second bore (67).

13. The rotor bearing mounting device (44) according to claim 9, wherein the fastening receptacle (57) has a height adjustment mechanism (71) by means of which the sliding bearing pads (18) are displaceable in the axial direction.

14. The rotor bearing mounting device (44) according to claim 9, wherein the fastening receptacle (57) has a positioning pin (63), which is configured to interact with a through hole (34) formed in the sliding bearing pad (18), in the region of the sliding bearing pad receiving surface (61).
